(19) United States
(12) Patent Application Publication
(10) Pub. No.: US 2021/0175759 A1
(43) Pub. Date: Jun. 10, 2021

(54) STATOR FOR AN ELECTRIC MACHINE AND ELECTRIC MACHINE

(71) Applicant: FEAAM GmbH, Neubiberg (DE)

(72) Inventor: Johannes GEROLD, Munchen (DE)

(21) Appl. No.: 16/950,812

(22) Filed: Nov. 17, 2020

(30) Foreign Application Priority Data
Nov. 18, 2019 (DE) 10 2019 131 068.7

(51) Int. Cl. H02K 1/16; H02K 1/14; H02K 3/48; H02K 1/18

(52) U.S. Cl. CPC H02K 1/165; H02K 1/185; H02K 3/48; H02K 1/148

(57) ABSTRACT

A stator (20) for an electric machine (21) is proposed, the stator (20) comprising slots (22) for receiving electric windings (23), and at least two teeth (24), wherein respectively one tooth (24) of the stator (20) is formed between two adjacent slots (22), wherein at least two of the teeth (24) have a recess (25) extending at least partially through the respective tooth (24), and within the recesses (25), at least two electric conductors (26) each are arranged which are short-circuited to one another. Moreover, an electric machine (21) is proposed.

The present application relates to a stator for an electric machine and an electric machine.

Typically, electric machines comprise a stator and a rotor that is movable to it. Electric machines may function as a motor type or a generator type, wherein electric energy is converted into kinetic energy or vice versa. During operation, a magnetic field of the rotor interacts with a magnetic field of the stator.

In order to operate the electric machine efficiently, an objective is to generate a torque as high as possible. Moreover, losses should be reduced in the electric machine. For this purpose, for example, so-called flow barriers may be provided within the stator. The flow barriers partially extend through the stator and are filled with air. However, even when flow barriers are used, losses may occur due to the harmonic components of the magnetomotive force which are not utilized for generating the torque.

One task to be solved is to proposes a stator for an electric machine which can be operated in an efficient manner. A further task to be solved is to propose an electric machine which can be operated in an efficient manner.

The tasks are solved by the subject matters of the independent claims. Advantageous configurations and further developments are indicated in the dependent claims.

According to at least one embodiment of the stator for an electric machine, the stator comprises slots for receiving electric windings. The stator has a longitudinal axis. The slots may be recessed in the stator. The slots each may extend along the entire longitudinal axis of the stator. The slots may be arranged completely within the stator. In this case, the slots do not have openings to the outside of the stator. It is further possible that the slots each have at least one opening. The openings, for example, may be arranged on an inner side of the stator. For example, the openings may be arranged on a side of the stator, where a rotor of the electric machine may be arranged. The slots may be distributed along the circumference of the stator. For example, the slots may be evenly distributed along the circumference of the stator.

The stator furthermore comprises at least two teeth, wherein one tooth of the stator respectively is formed between two adjacent slots. Thus, a tooth and a slot are alternately arranged along the circumference of the stator. Within the slots, electric windings of the stator may be arranged. For this purpose, an electric winding is wound around each tooth of the stator, for example. In this case, the electric windings are arranged within the slots at least in some places. It is further possible for an electric winding to be wound around every second tooth of the stator. In these cases, this is a concentrated winding. Other concentrated winding systems are also possible. The electric windings each have an electrically conductive material. The electric windings may be connected to power electronics and be configured to generate a rotating field. The teeth may be evenly distributed along the circumference of the stator. Furthermore, the teeth each may have the same extension along the circumference of the stator. However, it is also possible for the teeth to be differently sized.

At least two of the teeth have a recess extending at least partially through the respective tooth. The recesses each may extend through the stator completely along the longitudinal axis. This means, the recesses each may extend in parallel to the adjacent slots. The stator can have a plurality of laminated sheet packages into which the slots and the recesses are introduced. The laminated sheet packages can have iron. Recess correspondingly means the absence of the material of the laminated sheet packages or the absence of material carrying the magnetic flux, such that the magnetic flux is inhibited in the area of the recess.

Within the recesses, two electric conductors each are arranged which are short-circuited to one another. The electric conductors each have an electrically conductive material. For example, the electric conductors each are wires. The electric conductors may extend along the longitudinal axis of the stator completely through the stator. The electric conductors arranged within the same recess are short-circuited to one another. Furthermore, electric conductors arranged within different recesses may likewise be short-circuited to one another.

During operation of the electric machine, a voltage is induced in the electric conductors within the recesses. The voltage in the electric conductors, for example, is generated by the fundamental wave of the stator's magnetic field. Thus, the electric conductors are self-excited by the fundamental wave. The voltage generated in the electric conductors results in a current and thus to an additional magnetic flux. Since the electric conductors are short-circuited to one another, current may flow and a magnetic flux is generated. It has been shown that this additional magnetic flux results in the torque of the electric machine being increased and rotor losses being reduced. Moreover, undesired harmonic components of the magnetomotive force may be reduced significantly.

In this case, all harmonic components are deemed as being undesirable which are not utilized as an operating wave. These may be higher harmonics and/or sub-harmonics, wherein the terms higher and sub-, each refer to the order of the harmonics utilized as an operating wave. The reduction of the undesired harmonic, for example the fundamental wave which has the ordinal number of 1 allocated, in turn leads to the efficiency degree of the electric machine being increased or undesired acoustic impairments and vibrations being reduced.

The additional magnetic flux generated by the electric conductors may result in the fundamental wave and further sub-harmonics of the magnetomotive force being reduced. At the same time, the harmonic component utilized for generating the torque, which consequently is utilized as the operating wave, may be increased. Thus, the nominal torque of the electric machine may be increased.

Furthermore, due to the electric conductors within the recesses, the iron losses and magnetic losses of the electric machine are reduced. Thus, the efficiency degree of the electric machine is higher as a whole. This means, the electric machine can be operated more efficiently.

The recess including the electric conductors does not require any significant additional effort during manufacturing, since the stator's laminated sheet packages usually are punched parts anyway and the recess can be punched out in the same work step. The electric conductors may subsequently be arranged within the slots.

According to at least one embodiment, the recesses each extend in a radial direction, wherein the radial directions each run in parallel to a radius in a cross-section through the stator, and the radius runs through the respective tooth. The cross-section through the stator runs perpendicular to the longitudinal axis of the stator. The stator may have approximately the shape of a cylinder. The stator then has the shape of a circle in cross-section. The radial directions each run in parallel to a radius within the circle. The radial directions, in which the recesses respectively extend, each run in parallel to a radius through the respective tooth. This means that a radius running centrically through the tooth is assigned to each tooth. Along the respective radial direction, the recesses may extend partially or completely through the stator. Apart from the electric conductors, air may be arranged within the recesses. Thus, the recesses act as flow barriers within the stator. By arranging the electric conductors within the recesses, the torque generated by the electric machine during operation is increased. Moreover, the electric machine as a whole can be operated more efficiently.

According to at least one embodiment, at least every second tooth has a recess. This means that at least every second tooth has one of the recesses along the circumference of the stator. Around the teeth having no recesses, the electric windings of the stator may be wound. Thus, an electric winding is wound around every second tooth. This structure enables an efficient operation of the electric machine.

According to at least one embodiment, each tooth has one of the recesses.

According to at least one embodiment, at least one of the electric conductors cannot be electrically contacted from outside the stator. This can mean that the electric conductor is completely arranged within the stator. Moreover, the electric conductor is not arranged on an outside of the stator. Thus, the electric conductor is not accessible from outside the stator. An access to the electric conductor from outside the stator is not possible. Consequently, the electric conductor is not connected to power electronics. Thus, the electric conductor within the recesses serves as an electrically conductive material in which a voltage is induced during operation of the electric machine. The induced voltage results in current and an additional magnetic flux. As described above, this enables the electric machine to be operated more efficiently.

According to at least one embodiment, the electric conductors respectively do not fill the recess completely. This means that not the entire volume of the recesses is filled with the electric conductors. Apart from the electric conductors, the recesses may be filled with air. Since the electric conductors do not fill the recesses completely, the electric conductors may be placed easily within the recesses.

According to at least one embodiment, electric conductors within two recesses are electrically connected together. In the cross-section through the stator, the recesses are distributed along the circumference of the stator. The two recesses are arranged at different positions along the circumference of the stator. The electric conductors within the two recesses each may form a closed ring which partially extends through the two recesses. The ring is arranged completely within the stator, for example, so that it cannot be contacted from outside the stator. Thus, a voltage may be induced in the electric conductors during operation of the electric machine. As explained above, this enables the electric machine to be operated more efficiently.

According to at least one embodiment, electric conductors within two recesses are electrically connected together which are opposite to one another in a cross-section through the stator. Two recesses which are opposite to one another in a cross-section through the stator extend in a cross-section through the stator along a straight line.

According to at least one embodiment, electric conductors within two further recesses are electrically connected together, wherein the electric conductors within the two recesses are electrically isolated from the electric conductors within the two further recesses. The further recesses may have the same structure as the recesses. Thus, the electric conductors may be arranged within the two further recesses as described for the recesses.

Preferably, the stator has four further recesses, in which electric conductors are arranged. In this case, two further recesses respectively are opposite to one another in a cross-section through the stator. Moreover, the two recesses are opposite to one another in a cross-section through the stator. Electric conductors within recesses or further recesses, which are not opposite to one another in a cross-section through the stator, are electrically isolated from one another. Thus, a three-phase voltage develops within the electric conductors, which enables a constant additional torque. Thus, the electric machine as a whole can generate a higher torque during operation.

According to at least one embodiment, the electric conductors have a metal. The electric conductors, for example, have copper. Thus, the electric conductors constitute an electrically conductive material in which a voltage may be induced. This enables the electric machine to be operated efficiently.

According to at least one embodiment, the recesses each have an additional slot. This may mean that the recesses each are formed as an additional slot. The additional grove may be open towards an inside and/or towards an outside of the stator. It is further possible for the additional slot to be arranged completely within the stator sheet. The electric conductors arranged within the recesses enable the electric machine to be operated efficiently.

According to at least one embodiment, the recesses each have an additional slot which extends completely through the stator from an inside to an outside. The inside of the stator may be the side where a rotor of the electric machine may be arranged. In this case, the outside is the side of the stator facing away from the inside. Thus, the recesses extend further through the stator than the slots. The recesses thus act as flow barriers. Moreover, the electric conductors arranged within the recesses enable the electric machine to be operated efficiently.

Furthermore, an electric machine is proposed. According to at least one embodiment of the electric machine, the electric machine has a stator. Thus, all of the features of the described stator are also disclosed for the electric machine and vice versa. The electric machine further has a rotor that is movable relative to the stator. The rotor may be an internal rotor or an external rotor. If the rotor is an internal rotor, an outside of the rotor is facing the stator. The rotor may be arranged on a shaft of the electric machine. Between the stator and the rotor, an air gap may be arranged. The rotor may have permanent magnets. The permanent magnets may be arranged at the side of the rotor facing the stator. As described above, the electric machine has an increased efficiency degree and the losses are reduced. Thus, the electric machine may be operated more efficiently.

According to at least one embodiment of the electric machine, an operating wave of the magnetomotive force is different from a fundamental wave of the magnetic flux during operation. This means that a harmonic component of the magnetomotive force having an order of higher than 1 is used as the operating wave, for example. For example, the 7^{th} harmonic of the magnetomotive force is used as the operating wave. This means that this component of the magnetomotive force is utilized during operation of the electric machine for generating torque. In conjunction with the recesses and the electric conductors within the recesses, the use of a higher harmonic component than the fundamental wave as an operating wave enables the electric machine to be operated efficiently.

According to at least one embodiment of the electric machine, the recesses are in connection with an air gap arranged between the rotor and the stator. This means that the recesses are open towards the air gap. Consequently, air is partially present within the recesses. The recesses thus form flow barriers. Furthermore, the recesses may be closed towards a side of the stator facing away from the rotor. This means that the recesses do not extend completely but only partially through the stator in the radial directions. This results in rotor losses being further reduced and thus the efficiency degree being increased. The electric machine may therefore be operated more efficiently.

According to at least one embodiment of the electric machine, the recesses are open towards the side of the stator facing away from the rotor. This means that the recesses may be open towards an outside of the stator. In addition, the recesses may be in connection with the air gap. In this case, the recesses extend completely through the stator in the radial directions. However, it is also possible for the recesses not to be in connection with the air gap. The recesses thus extend through the stator in some places in the radial directions. In each case, the electric conductors within the recesses enable the electric machine to be operated efficiently.

Hereinafter, the stator described herein and the electric machine will be explained in more detail in conjunction with exemplary embodiments and the associated Figures.

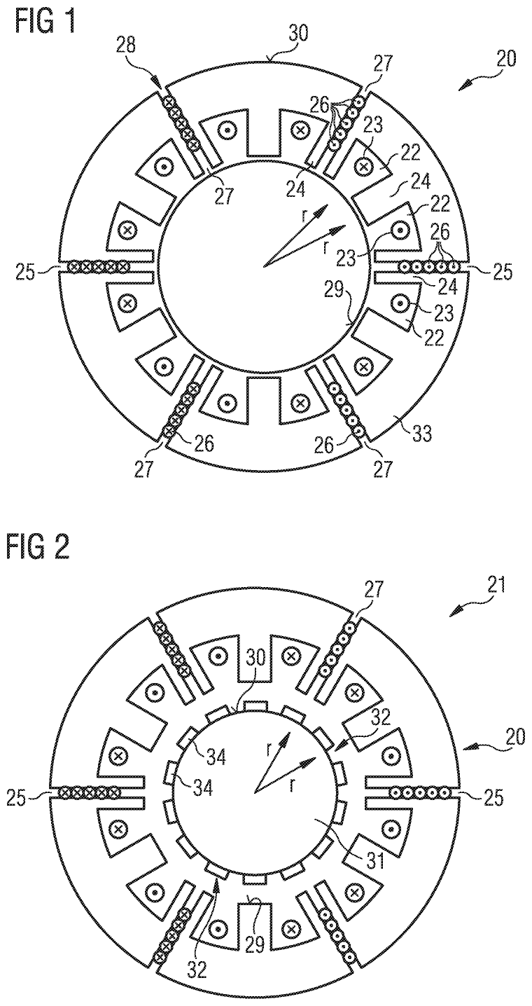

In FIG. 1, a cross-section through an exemplary embodiment of the stator is shown.

In FIG. 2, a cross-section through an exemplary embodiment of the electric machine is shown.

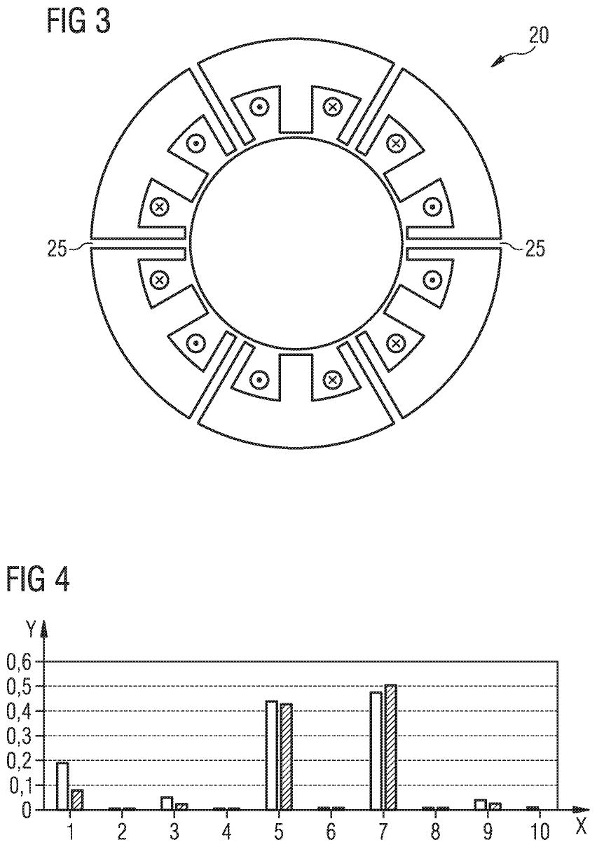

FIG. 3 shows a cross-section through an example of a stator.

In FIG. 4, the magnetic flux density within the air gap is plotted for different harmonic components.

In FIG. 5, the torque over time is plotted for different electric machines.

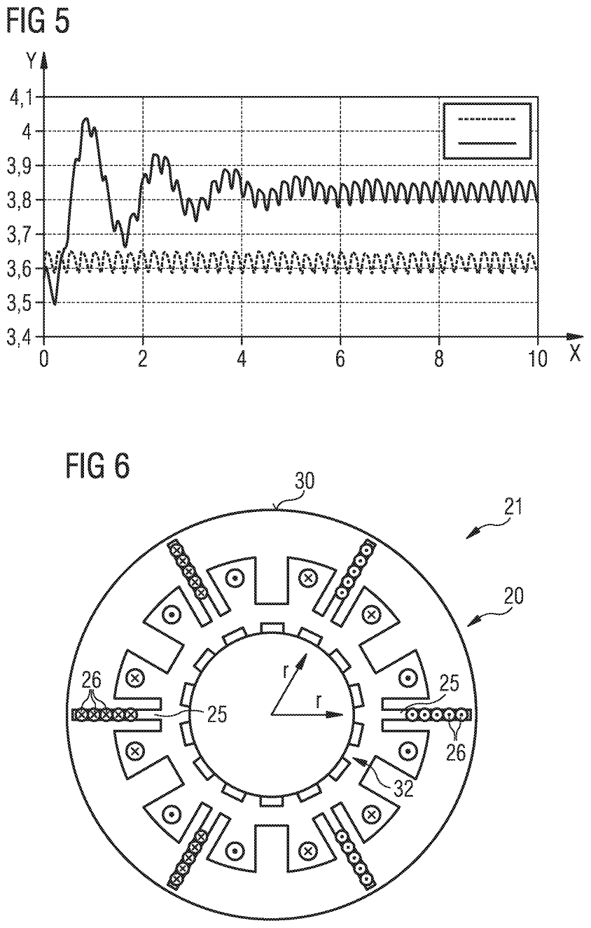

In FIG. 6, a cross-section through a further exemplary embodiment of the electric machine is shown.

FIG. 1 shows a cross-section through an exemplary embodiment of the stator 20 for an electric machine 21. The stator 20 has slots 22 for receiving electric windings 23. In total, the stator 20 has twelve slots 22. The slots 22 are arranged along the circumference of the stator 20. Moreover, the slots 22 are open towards an inside 29 of the stator 20. Within the slots 22, electric windings 23 are arranged. It is illustrated in FIG. 1 in which direction electric current flows within the electric windings 23 during operation of the electric machine 21. The slots 22 extend partially through the stator 20 in radial directions r. The radial directions r each run in parallel to a radius in a cross-section through the stator 20. The stator 20 has a plurality of laminated sheet packages 33 into which the slots 22 are introduced.

Moreover, the stator 20 has at least two teeth 24, wherein one tooth 24 of the stator 20 is respectively formed between two adjacent slots 22. The teeth 24 are arranged distributed along the circumference of the stator 20. In total, the stator 20 has twelve teeth 24. The electric windings 23 are wound around each tooth 24 along the circumference of the stator 20.

The teeth 24, around which none of the electric windings 23 is wound, each have a recess 25 extending at least partially through the respective tooth 24. Thus, every second tooth 24 has a recess 25. The recesses 25 each extend in a radial direction r, wherein the respective radial direction r runs through the respective tooth 24. The recesses 25 each may comprise an additional slot 28. The recesses 25, like the slots 22, extend completely through the stator 20 along a longitudinal axis of the stator 20. Moreover, the recesses 25 or the additional slots 28 extend completely through the stator 20 from an inside 29 towards an outside 30 of the stator 20.

Furthermore, at least two electric conductors 26 which are short-circuited to one another, are arranged within the recesses 25. In this exemplary embodiment, five electric conductors 26 each are arranged within each recess 25. The electric conductors 26 have an electrically conductive material, for example, a metal. The electric conductors 26 each do not fill the recesses completely. This means that, apart from the electric conductor 26, air is arranged within the recesses 25. At least one of the electric conductors 26 is arranged within the stator 20 such that the electric conductor 26 cannot be electrically contacted from outside the stator 20. This means that this electric conductor 26 is not accessible from outside the stator 20.

In FIG. 1, it is further illustrated, in which direction current flows in the electric conductors 26 during operation of the electric machine 21. This is achieved in that electric conductors 26 within two recesses 25, which are opposite to one another in a cross-section through the stator 20, are electrically connected together. Electric conductor 26 in adjacent recesses 25 are electrically isolated from one another. Moreover, the stator 20 has four further recesses 27. The further recesses 27 have the same structure as the recesses 25. The electric conductors 26 within two further recesses 27, which are opposite to one another in a cross-section through the stator 20, are electrically connected together. This applies to all of the four further recesses 27. Thus, the stator 20 has three pairs of recesses 25, 27, in which the electric conductors 26 are short-circuited to one another for each pair. Moreover, in each pair of the recesses 25, 27, the recesses 25, 27 are arranged at opposite sides of the stator 20.

In FIG. 2, a cross-section through an exemplary embodiment of the electric machine 21 is shown. The electric machine 21 has the stator 20 and a rotor 31 that is movable relative to the stator 20. The stator 20 has the structure shown in FIG. 1. The rotor 31 is arranged as an internal rotor at the inside 29 of the stator 20. Between the stator 20 and the rotor 31, an air gap 32 is arranged. The recesses 25, 27 of the stator 20 are in connection with the air gap 32. Moreover, the recesses 25, 27 extend completely through the stator 20 in radial directions r, so that the recesses 25, 27 are open toward the side of the stator 20 facing away from the rotor 31. The rotor 31 has 14 permanent magnets 34 arranged at an outside 30 of the rotor 31. The outside 30 of the rotor 31 is facing the air gap 32. In the electric machine 21, the operating wave of the magnetomotive force is different from the fundamental wave of the magnetic flux during operation. This means that it is not the fundamental wave of the magnetic flux that is utilized for generating torque, but that it is the seventh harmonic component of the magnetomotive force.

In FIG. 3, a cross-section through an example of a stator 20 is shown. The example shown in FIG. 3 is not an exemplary embodiment. In contrast to the stator 20 shown in FIG. 1, no electric conductors 26 are arranged within the recesses 25 in the example in FIG. 3.

In FIG. 4, the magnetic flux density within the air gap 32 is plotted for different harmonic components. The order of the harmonic components is plotted on the x-axis. The magnetic flux density is potted in Tesla on the y-axis. The white bars indicate the magnetic flux density for the example of a stator 20 shown in FIG. 3, and the black bars indicate the magnetic flux density for the exemplary embodiment of the stator 20 shown in FIG. 1. Thus, FIG. 4 illustrates the advantages of the exemplary embodiment of the stator 20 shown in FIG. 1.

In an electric machine having the stator 20 shown in FIG. 1, the 7^{th} harmonic component of the magnetomotive force is used as an operating wave. This means that the component is utilized for generating torque. Other components of the magnetomotive force have the effect of losses. Consequently, it is advantageous to reduce the magnetic flux density of sub-harmonics and higher harmonics. As compared to an electric machine having the stator 20 of FIG. 3, the magnetic flux density for the fundamental wave is significantly reduced in an electric machine having the exemplary embodiment of the stator 20 of FIG. 1. Further, the magnetic flux density for the harmonic components of the orders 3, 5 and 9 is reduced. Moreover, for an electric machine having the stator 20 of FIG. 1, the magnetic flux density of the 7^{th} harmonic component is higher than for an electric machine having the stator 20 of FIG. 3. Thus, with an electric machine having the stator 20 of FIG. 1 and the exemplary embodiment of the electric machine 21 of FIG. 2, a higher torque may be generated during operation, and the losses are reduced as compared to an electric machine having the stator 20 of FIG. 3, which has no electric conductors 26. Thus, the electric conductors 26 enable an electric machine having the stator 20 of FIG. 1 and the electric machine 21 of FIG. 2 to be operated more efficiently than an electric machine having the stator 20 of FIG. 3.

In FIG. 5, the torque over time is plotted for two different electric machines 21. Time is plotted in seconds on the x-axis. The torque is plotted in Nm on the y-axis. The dashed line shows the torque for an electric machine having the stator 20 of FIG. 3. The solid line shows the torque for an electric machine having the stator 20 of FIG. 1. For the stator of FIG. 1, the torque shows a longer transient response, however in total, the torque has a higher value than for the stator 20 of FIG. 3. Thus, the electric conductor 26 within the recesses 25 advantageously enable a higher torque to be generated.

In FIG. 6, a cross-section through a further exemplary embodiment of the electric machine 21 is shown. In contrast to the exemplary embodiments shown in FIGS. 1 and 2, the recesses 25 extend not completely but only partially through the stator 20 in radial directions r. The recesses 25 each are open towards the air gap 32. Towards an outside 30 of the stator 20 facing away from the air gap 32, the recesses 25 are closed.

This structure to a decrease of the magnetic resistance for the magnetic flux developed by the voltage induced in the electric conductors 26. Thereby, the losses in the electric machine 21 are further reduced. The torque has the same value as the exemplary embodiment of the electric machine 21 shown in FIG. 2. Consequently, the efficiency degree and thus the efficiency for the exemplary embodiment shown in FIG. 6 is higher than for the exemplary embodiment shown in FIG. 2.

1. A stator for an electric machine, the stator comprising:
slots for receiving electric windings, and
at least two teeth, wherein respectively one tooth of the stator is formed between two adjacent slots, wherein
at least two of the teeth have a recess extending at least partially through the respective tooth, and
within the recesses, at least two electric conductors each are arranged which are short-circuited to one another.

2. The stator according to claim 1, in which the recesses each extend in a radial direction, wherein the radial directions each run in parallel to a radius in a cross-section through the stator, and the radius runs through the respective tooth.

3. The stator according to claim 1, in which at least every second tooth has one of the recesses.

4. The stator according to claim 1, in which at least one of the electric conductors cannot be electrically contacted from outside the stator.

5. The stator according to claim 1, in which the electric conductors respectively do not fill the recesses completely.

6. The stator according to claim 1, in which electric conductors within two recesses are electrically connected together.

7. The stator according to the preceding claim, in which electric conductors within two further recesses are electrically connected together, wherein the electric conductors within the two recesses are electrically isolated from the electric conductors within the two further recesses.

8. The stator according to claim 1, in which the electric conductors have a metal.

9. The stator according to claim 1, in which the recesses each comprise an additional slot.

10. The stator according to claim 1, in which the recesses each have an additional slot extending completely through the stator from an inside to an outside.

11. An electric machine having a stator according to any one of the preceding claims, and a rotor that is movable relative to the stator.

12. The electric machine according to the preceding claim, in which an operating wave of the magnetomotive force is different from a fundamental wave of the magnetic flux during operation.

13. The electric machine according to claim 11, in which the recesses are in connection with an air gap arranged between the rotor and the stator.

14. The electric machine according to claim 11, in which the recesses are open towards the side of the stator facing away from the rotor.
